(19) United States
(12) Patent Application Publication
(10) Pub. No.: US 2014/0068426 A1
(43) Pub. Date: Mar. 6, 2014

(54) SYSTEM AND METHOD OF MODIFYING ORDER AND STRUCTURE OF A TEMPLATE TREE OF A DOCUMENT TYPE BY MERGING COMPONENTS OF THE TEMPLATE TREE

(71) Applicants: Gururaj Potnis, Bangalore (IN); Mohit Kataria, Bangalore (IN)

(72) Inventors: Gururaj Potnis, Bangalore (IN); Mohit Kataria, Bangalore (IN)

(21) Appl. No.: 13/664,241

(22) Filed: Oct. 30, 2012

(30) Foreign Application Priority Data
Sep. 5, 2012 (IN) 3654/CHE/2012

(51) Int. Cl. G06F 17/21

(52) U.S. Cl. 715/256

(57) ABSTRACT

A document editing tool that allows merging a first clause and a second clause to obtain a merged clause based on a set of instructions is provided. The set of instructions includes displaying a document template tree, processing a selection of the first clause from the document template tree, processing a selection of the second clause to merge with the first clause, processing an input including an indication to combine the first clause with the second clause, and generating, by the processor, the merged clause in the document template tree that includes a content of the first clause and a content of the second clause. The document template tree includes one or more parent clauses and one or more child clauses that are arranged hierarchically. The first clause includes a first metadata. The second clause includes a second metadata.

This application claims the benefit of Indian Patent Application No. 3654/CHE/2012 filed on Sep. 5, 2012, whereby the contents of the application in its entirety, is herein incorporated by reference.

### BACKGROUND

1. Technical Field

The embodiments herein generally relate to editing of a document template tree by changing and/or modifying an order and/or structure of the document template tree to be used for generating an electronic document, and more particularly, editing the document template tree by merging one or more components of the document template tree such that a coherence, structure and functionality of the document template tree remains intact.

2. Description of the Related Art

Small and large business entities generate several documents like contracts, proposals, correspondence etc. to serve business purposes and capture communication/understanding with customers, vendors, partners, other entities or internal audience. Typically, a text and import of each document in relation to engagement vary with the intended purpose and context of each document. Document creation relies heavily on human memory and past experience of an author who creates the document.

Typically, a new document in a business scenario is created using templates from a library or from precedent documents that were created in similar contexts. For instance, to draft a “Goods Purchase Agreement”, typically a user starts creating the intended document by choosing a standard template of the goods purchase agreement which has been pre-stored as a template file in either a document management system or otherwise stored in folders in one or more formats.

Alternatively, the user chooses a “Goods Purchase Agreement” document that was previously drafted for counter-party as the starting point. Hence the author may have several templates, any of which can be a starting point. Using one such Goods Purchase Agreement template, the user will customize the content based on his/her judgment to suit current context. Further, each template corresponds to its own context when it was prepared and will be required to be changed to suit the current context. For example, a typical template may have one or more clauses and corresponding one or more sub-clauses. Any chosen template will require modification such as deletion, replacement with apt text, and/or addition of new text to the existing clauses and sub-clauses.

The conventional document editing tools do not have the ability, to edit a content of the document template, add a new clause thus formed to the document template and store the new versions of existing clauses and/or sub-clauses in the library as and when they are formed. This is due to the fact that such tools are typically populated with frozen template documents. Once a template is fed into the system, subsequent changes or evolution of better versions of clauses and sub-clauses do not add back to the templates dynamically. Authors are required to begin with the same base template document for every new requirement for the creation of documents of a particular document type.

Because of this inefficiency, users continue to use standard base templates and modify those as required for the context, but this entails extensive manual intervention to complete every document. This makes context specific document editing a costly process, and requiring substantial human intervention. Accordingly there remains a need for a document editing tool that allows creating new document templates specific to a context using an extensive template tree of that document type.

### SUMMARY

In view of the foregoing, an embodiment herein provides a document editing tool that allows merging a first clause and a second clause to obtain a merged clause. The document editing tool includes a memory unit that stores a database and a set of instructions. The database includes a master clause database and one or more document template trees that correspond to one or more document types. A document template tree is selected from the one or more document template trees. The document editing tool further includes a processor that executes the set of instructions. The set of instructions includes (a) displaying, by a display unit, a document template tree. The document template tree includes one or more parent clauses and one or more child clauses that are arranged hierarchically, (b) processing a selection of the first clause from the document template tree. The first clause includes a first metadata. (c) processing a selection of the second clause to merge with the first clause. The second clause includes a second metadata. (d) processing an input, by an input unit, including an indication to combine the first clause with the second clause, and (e) generating by the processor, the merged clause in the document template tree includes a content of the first clause and a content of the second clause. An electronic document may be generated based on the merged clause.

The indication to combine the first clause with the second clause may include dragging and dropping at least one of (i) the first clause into the second clause, or (ii) the content of the first clause into the content of the second clause. The indication to combine further may include dragging and dropping at least one of (i) the second clause into the first clause, or (ii) the content of the second clause into the content of the first clause. The second clause may be selected from the document template tree that includes the first clause. The document template tree is a first document template tree that includes the first clause, and the second clause may be selected from a second document template tree. The second document template tree is stored in a master clause database.

The method further includes editing content of at least one of (i) the first clause, (ii) the second clause, and (iii) the merged clause to obtain an edited merged clause; and storing the edited merged clause in the document template tree and the master clause database by generating a third metadata for the edited merged clause based on the first metadata and the second metadata. The editing includes editing with reference to at least one of: (i) a gender, (ii) a singular or a plural, (iii) a removal of redundancy, (iv) an inclusion of a linking content between the content of the first clause and the content of the second clause.

In another embodiment, a method of merging a first clause and a second clause to obtain an edited merged clause is provided. The method includes (a) displaying, by a display unit, a document template tree that is stored in a master clause database of a database. The document template tree includes one or more parent clauses and one or more child clauses that are arranged hierarchically. The database is stored in a memory unit of a document editing tool. (b) processing by a processor a selection of the first clause from the document template tree that is stored in the master clause database. The first clause includes a first metadata. (c) processing by the processor a selection of the second clause to merge with the first clause. The second clause includes a second metadata. (d) processing an input, from an input unit including an indication to combine the first clause with the second clause, (e) generating a merged clause in the document template tree includes a content of the first clause and a content of the second clause, and (f) updating at least one of (i) the first clause, (ii) the second clause, and (iii) the merged clause to obtain the edited merged clause.

An electronic document may be generated based on the edited merged clause. The method further includes updating the edited merged clause in the document template tree and a master clause database by generating a third metadata for the edited merged clause based on the first metadata and the second metadata.

In yet another embodiment, a document editing tool that allows merging a first clause and a second clause to obtain a merged clause is provided. The document editing tool includes (a) a memory unit that stores (i) a set of modules, and (ii) a database that includes a master clause database and one or more document template trees that correspond to a plurality of document types, (b) a display unit that is capable of displaying the one or more document template trees stored in the master clause database, and (c) a processor that executes the set of modules. The set of modules includes (i) a clause selection module that is capable of processing a selection of the first clause and the second clause, (ii) a clause combination module that is capable of processing an input including an indication to combine the first clause with the second clause, and (iii) a clause merge module that is capable of generating a merged clause that includes a content of the first clause and a content of the second clause.

The set of modules of the memory unit further includes a clause editing module that is capable of editing at least one of (i) the content of the first clause, (ii) the content of the second clause, and (iii) a content of the merged clause to obtain an edited merged clause. A metadata update module of the memory unit is capable of updating a third metadata for the edited merged clause based on the first metadata and the second metadata. A document update module of the memory unit that is capable of updating the edited merged clause in the document template tree and the master clause database.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of a user communicating with a user system to edit content of a clause associated with a document template tree using a document editing tool according to an embodiment herein;

FIG. 2 illustrates an exploded view of the document editing tool of FIG. 1 according to an embodiment herein;

FIG. 3 illustrates an exemplary view of a document template tree stored in a master clause database of the database of FIG. 2 according to an embodiment herein;

FIG. 4A illustrates an exemplary view of content associated with one or more child clauses of the safety and health policy of the document template tree of FIG. 3 according to an embodiment herein;

FIG. 4B illustrates an exemplary view of content associated with one or more child clauses of the sanitary facilities policy of the document template tree of FIG. 3 according to an embodiment herein;

FIG. 4C is a flow diagram illustrating merging of a first clause of a document template tree with a second clause to obtain an edited merged clause according to an embodiment herein;

FIG. 4D illustrates an exemplary view of merging the safety and health policy with the sanitary facilities policy of the document template tree of FIG. 3 by dragging content of the safety and health policy according to an embodiment herein;

FIG. 4E illustrates an exemplary view of merging the safety and health policy with the sanitary facilities policy of the document template tree of FIG. 3 by dragging content of the sanitary facilities policy according to an embodiment herein;

FIG. 4F illustrates an exemplary view of a content of an edited safety, health and sanitary facilities policy according to an embodiment herein;

FIG. 4G illustrates flow diagrams of various methods of combining a first clause with a second clause to obtain a merged clause that is edited to obtain an edited merged clause according to an embodiment herein; and

FIG. 5 illustrates a schematic diagram of a computer architecture according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

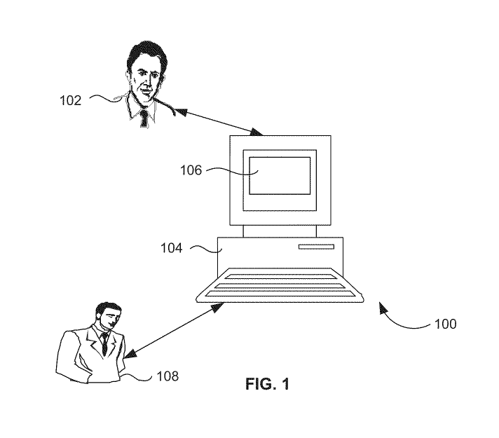

As mentioned, there remains a need for a document editing tool that allows a user to edit content of a document template tree to be used for generating an electronic document by changing and/or modifying an order and/or structure of a document template tree. The embodiments herein achieve this by providing sub-modules of the document editing tool that allows a dynamic structuring of the document template tree. The document template tree is stored in a master clause database of a database. The master clause database includes one or more similar such document template trees that correspond to one or more document types. The dynamic structuring of the document template tree includes merging a clause of the document template tree with another clause that is selected from the same document template tree or a different document template tree to obtain a new alternative clause (a merged clause). Herein throughout description of various embodiments, the term clause refers to a parent clause or a child-clause or a sub-child clause of a document template tree. Similarly, the term alternative clause refers to an alternative parent clause or an alternative child clause or an alternative sub-child clause of a document template tree. Referring now to the drawings, and more particularly to FIGS. 1 through 5, where similar reference characters denote corresponding features consistently throughout the figures, there are shown preferred embodiments.

FIG. 1 illustrates a system view 100 of a user 102 communicating with a user system 104 to edit content of a clause associated with a document template tree using a document editing tool 106 according to an embodiment herein. The document template tree includes one or more parent clauses with corresponding one or more alternative parent clauses. Each parent clause of the document template tree is in turn arranged as a tree that may include one or more child clauses with corresponding one or more alternative child clauses. Similarly, the document template tree may include various levels of clauses (e.g., sub-child clauses, sub-sub-child clauses, etc). The document template tree includes such clauses (e.g., parent clauses, child clauses, and sub-child clauses) that are arranged hierarchically.

Alternative (competing) clauses are the different forms of text of the parent clause, child-clause and/or sub-child-clause with a metadata. The metadata is used to qualify content of the alternative clauses of the document template tree. For each new that is formed by editing the document template tree formed, metadata is formulated. Further, the metadata are of two types such as a subjective metadata and an objective metadata. An addition of the subjective metadata needs assistance of a domain expertise. For example, in the creation of a new document by the drafter 108, the subjective metadata would be what is the risk level associated with each of alternative versions of the clause? Whereas, an addition of the objective metadata does not need any such domain expertise. For example, how many times a particular version of a parent clause from a document template tree was used?

In one embodiment, the user 102 has an authentication to create, add, modify, edit, merge, and/or delete content associated with the clause of the document template tree. A drafter 108 (e.g., an end user, contract drafter), drafts an electronic document using content of the document template tree. This document template tree will prevent loss of relevant information while ensuring better construct of the electronic document. In one embodiment, the drafter 108 may also be a user 102, can have authentication to modify content associated with the clause of the document template tree.

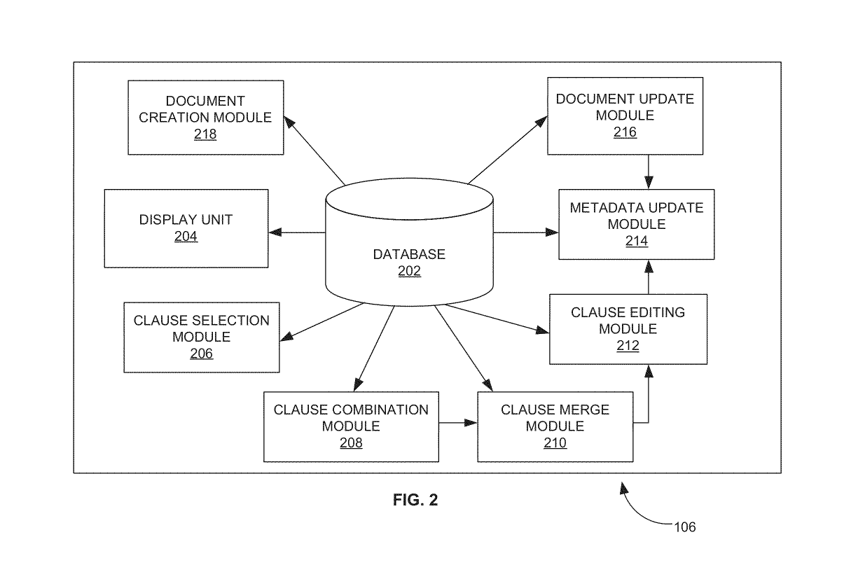

FIG. 2 illustrates an exploded view of the document editing tool 106 of FIG. 1 according to an embodiment herein. The document editing tool 106 includes a memory unit having set of instructions, further includes a database 202, a display unit 204, a clause selection module 206, a clause combination module 208, a clause merge module 210, a clause editing module 212, a metadata update module 214, a document update module 216, and a document creation module 218. The database 202 includes one or more master clause databases (not shown in the figures) for storing one or more document template tree.

The display module 204 provides a user interface of the one or more document template tree to the user 102 and the drafter 108. The clause selection module 206 processes a user input for selection of one or more clauses from the one or more document template tree (e.g., a first clause and a second clause). The clause combination module 208 process an input includes an indication of merging the first clause of a document template tree to the second clause. The clause merge module 210 generates a merged clause that includes a content of the first clause and a content of the second clause. The clause editing module 212 processes a user input for editing the content of the first clause, the content of the second clause and/or a content of the merged clause to obtain an edited merged clause. The metadata update module 214 processes a user input and allows the user 102 to create a metadata for each of new alternative clauses (e.g., the edited merged clause), and/or to edit a metadata of existing alternative clauses.

The document update module 216 updates each of new alternative clauses to a document template tree and the master clause database. Using, the document creation module 218, the drafter 108 creates an electronic document (e.g., agreement, contract, and/or proposal) that may include the content of the edited merged clause in addition to content that may be selected from other clauses.

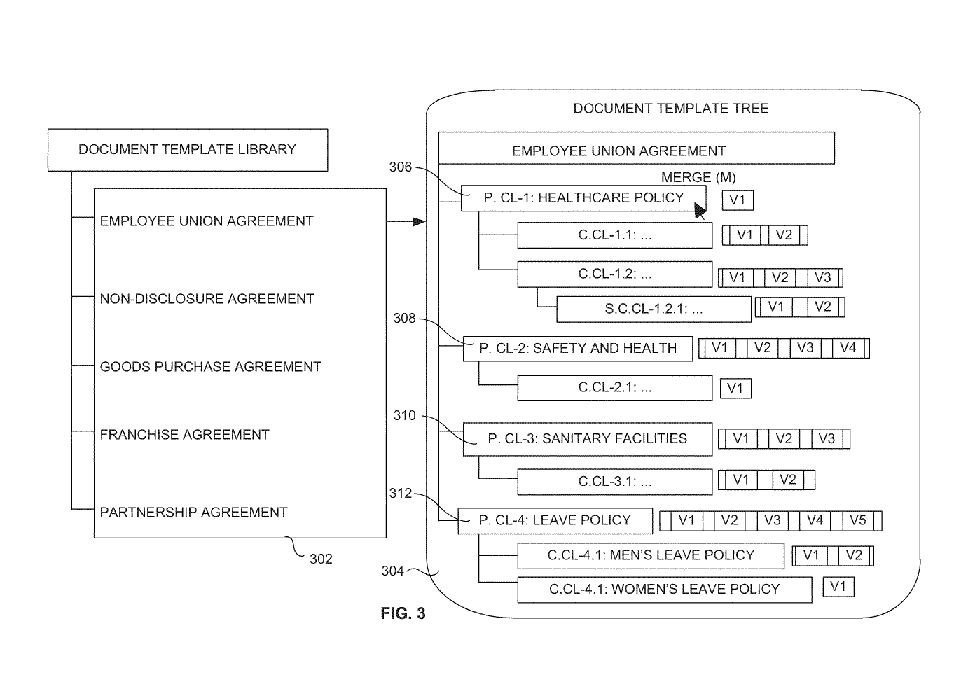

FIG. 3 illustrates an exemplary view of a document template tree 304 stored in a master clause database 302 of the database 202 of FIG. 2 according to an embodiment herein. The master clause database 302 includes one or more document template tree that corresponds to various document types are provided by the user 102. The user 102 selects a document template tree from the one or more document template tree, which he/she needs to edit. For example, when the user 102 selects an agreement (e.g., an employee union agreement) stored in the master clause database 302, clause titles of the employee union agreement (parent clauses titles, child clauses titles, and sub child-clauses titles with corresponding alternative clauses) with their associated content are provided to the user 102 as the document template tree 304. In one embodiment, the drafter 108 drafts the employee union agreement using the document template tree 304. Other similar document template tree that may be stored in the master clause database 302 includes a contract or agreements such as a non-disclosure agreement, a goods purchase agreement, a franchise agreement and/or a partnership agreement, etc.

The user 102 and the drafter 108 may view content associated with the clauses of the document template tree 304 by clicking on titles of the clauses. For example, content associated with the employee union agreement is displayed to the user 102 and the drafter 108 when they click on the clause employee union agreement. The document template tree 304 of the employee union agreement may include various parent clauses such as a healthcare policy 306, a safety and health policy 308, a sanitary conditions policy 310, and a leave policy 312 with their corresponding alternative clauses. The drafter 108 views content associated with the parent clauses and includes one or more desired parent clauses or desired one or more child clauses associated with the one or more parent clauses in the employee union agreement by clicking desired clause titles.

The drafter 108 may also compare content and metadata associated with one or more alternative clauses (e.g., the sanitary conditions policy 310 has 3 alternative clauses) and includes a desired alternative clause in an electronic document to be generated. In one embodiment, the document editing tool 106 provides an option to the user 102 to indicate merging a clause of a document template tree to another clause by performing a right click on a title of the clause.

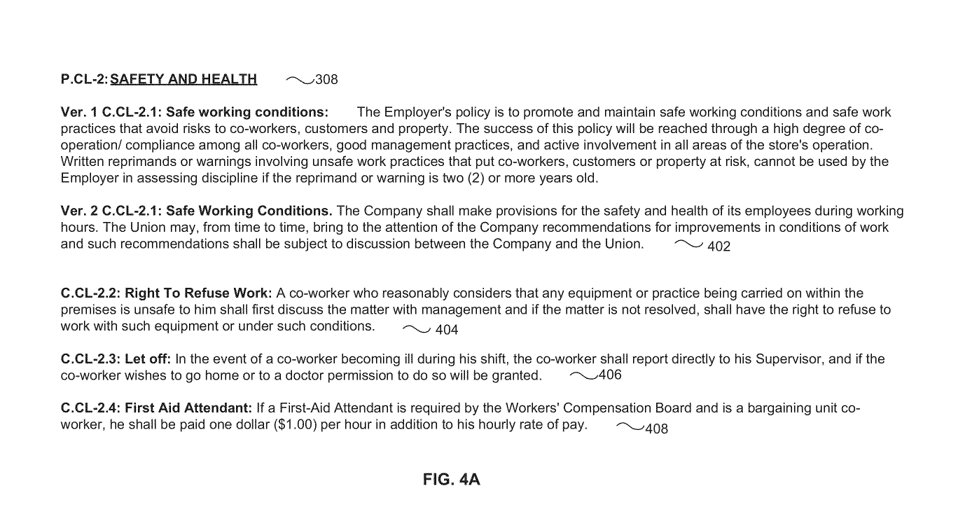

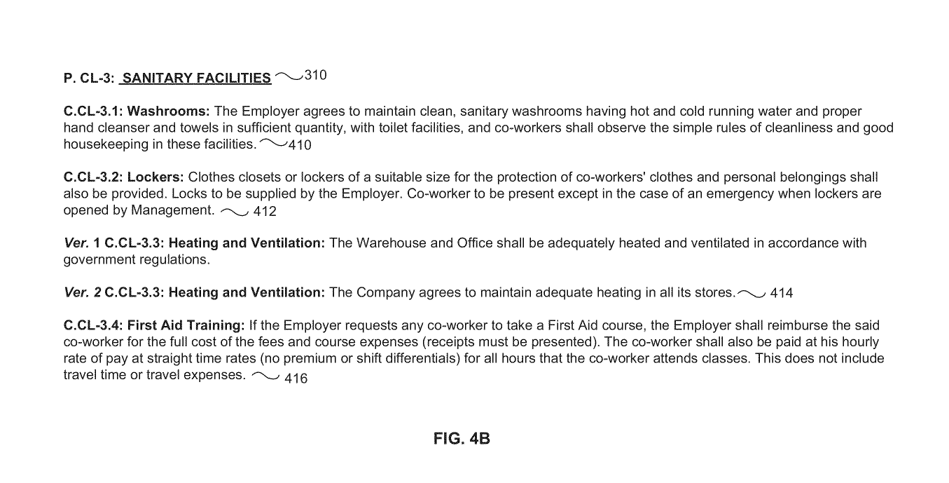

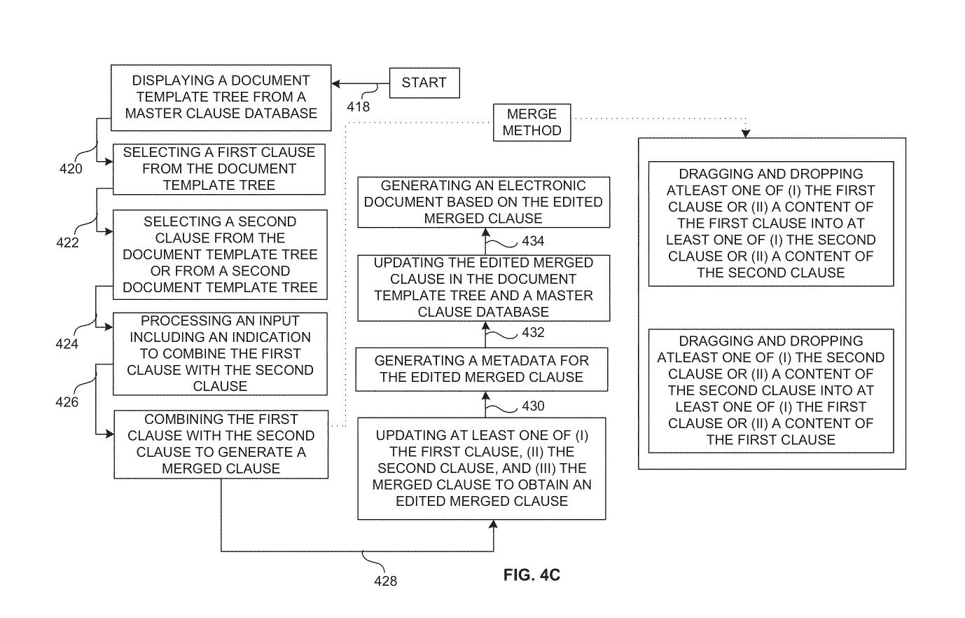

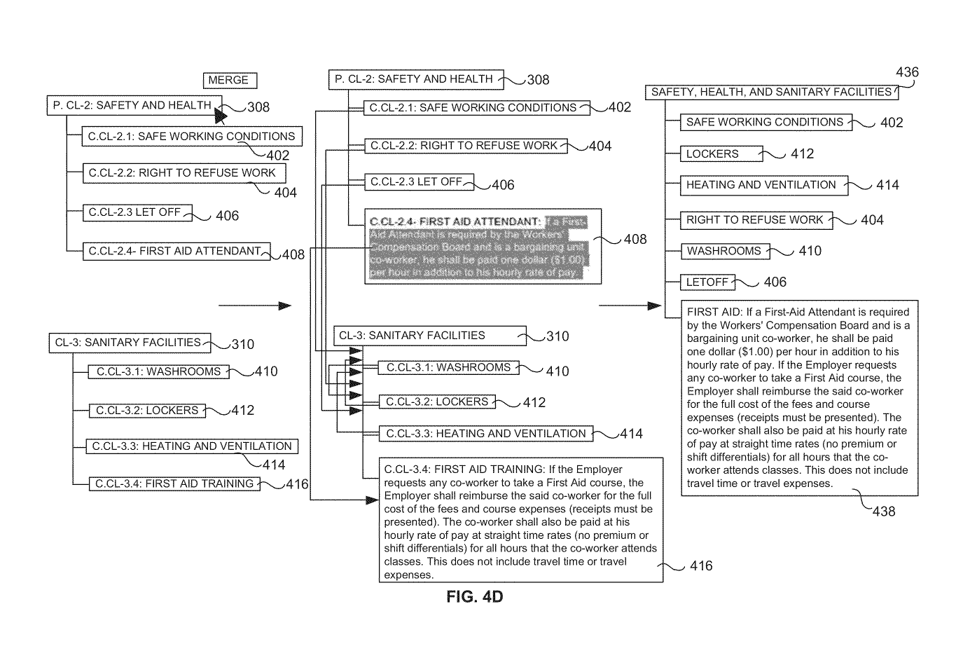

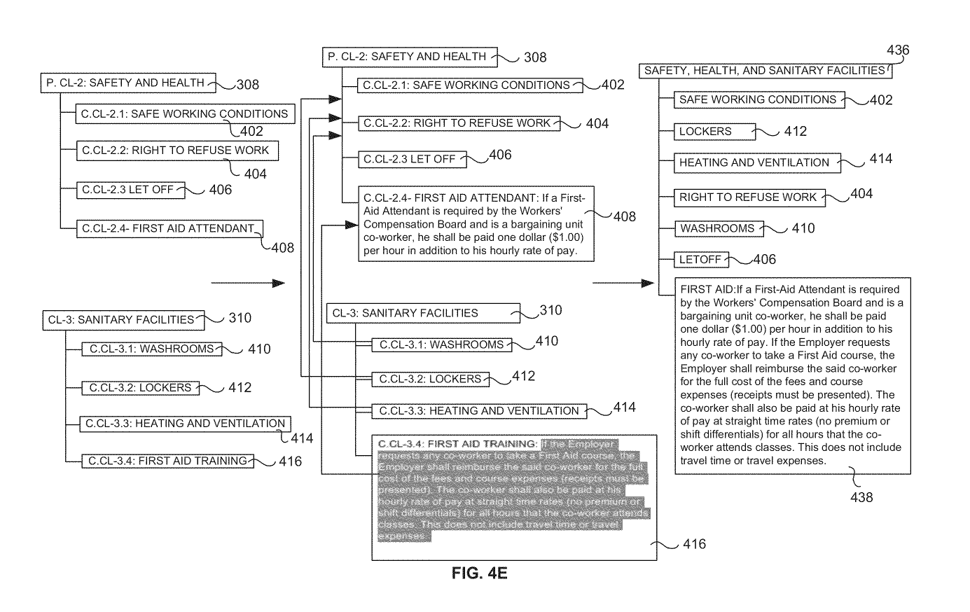

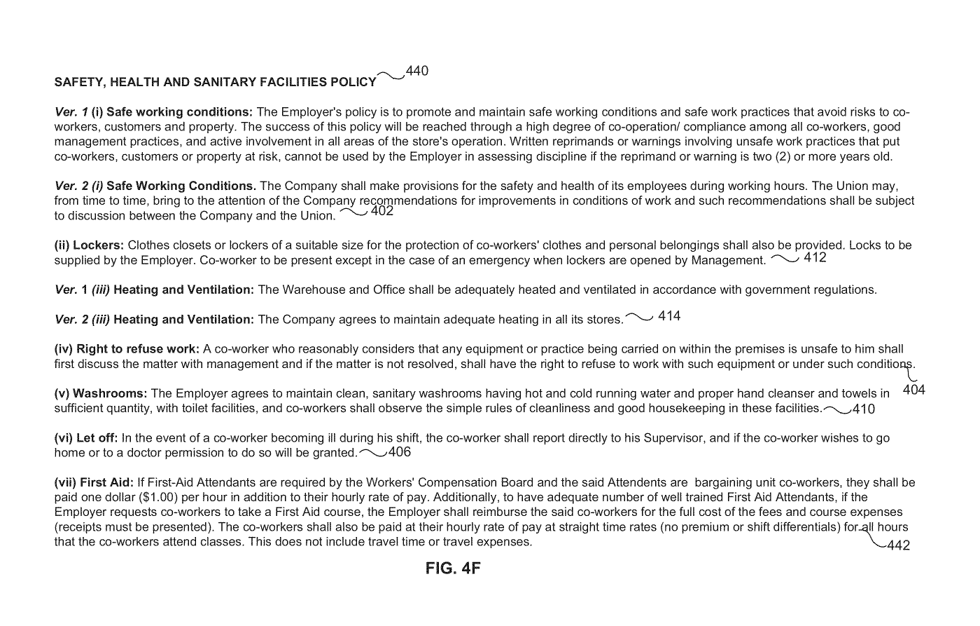

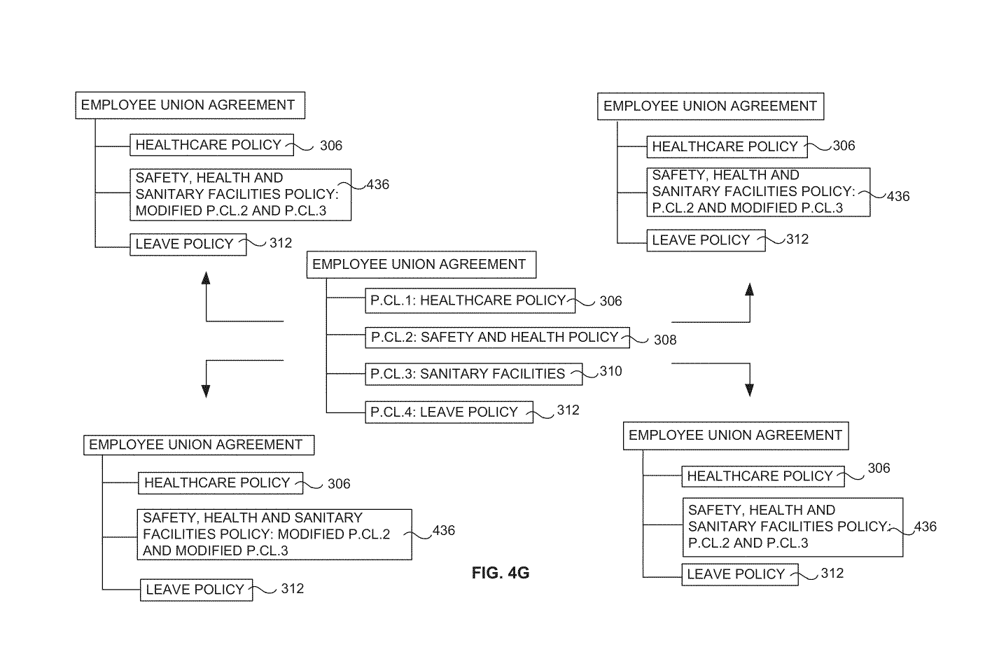

FIG. 4A illustrates an exemplary view of content associated with one or more child clauses of the safety and health policy 308 of the document template tree 304 of FIG. 3 according to an embodiment herein. The safety and health policy 308 includes child clauses such as a safe working conditions policy 402, a right to work policy 404, a let off policy 406, and a first aid attendant policy 408.

FIG. 4B illustrates an exemplary view of content associated with one or more child clauses of the sanitary facilities policy 310 of the document template tree 304 of FIG. 3 according to an embodiment herein. The sanitary facilities policy 310 includes child clauses washrooms policy 410, a lockers policy 412, a heating and ventilation policy 414, and a first aid training policy 416.

FIG. 4C is a flow diagram illustrating merging of a first clause of a document template tree with a second clause to obtain an edited merged clause according to an embodiment herein. In step 418, the display unit 204 of FIG. 2 displays the document template tree that is stored in the master clause database 302 of FIG. 3 of database 202 to the user 102. In step 420, a processor of the document editing tool 106 of FIG. 1 executes the clause selection module 206 for a selection of the first clause from the document template tree. In step 422, the processor executes the clause selection module 206 also for a selection of the second clause. The second is selected from the same document template tree or from other document template tree that is stored in the master clause database 302. In step 424, the clause combination module 208 processes an indication from an input unit for merging the first clause with the second clause. For example, the input unit is mouse, keyboard, touch screen, stylus, etc. In step 426, the clause merge module 210 combines and generates a merged clause that includes a content of the first clause and a content of the second clause.

In one embodiment, combining of the first clause and the second clause includes dragging and dropping at least one of (i) the first clause into the second clause, and/or (ii) the content of the first clause into the content of the second clause.

In another embodiment, combining of the first clause and the second clause includes dragging and dropping at least one of (i) the second clause into the first clause, and/or (ii) the content of the second clause into the content of the first clause.

In step 428, the clause editing module 212 edits the content of (i) the first clause, (ii) the second clause, and (iii) the merged clause to obtain an edited merged clause. Editing the content includes modifying the content with reference to (i) a gender, (ii) a singular or a plural, (iii) a removal of redundancy, (iv) an inclusion of a linking content between the first clause and the second clause. In step 430, the metadata update module 214 process a user input to generate a third metadata for the edited merged clause based on a first metadata of the first clause and a second metadata of the second clause. In step 432, the document update module 216 updates the edited merged clause to the document template tree and to the master clause database 302. In step 434, the drafter 108 may include the edited merged clause to an electronic document that needs to be generated.

For example, when the user 102 intends to generate a clause safety, health and sanitary facilities policy by merging the safety and health policy 308 and the sanitary facilities policy 310 of FIG. 3, the user 102 selects the document template tree 304 from the master clause database 302. The display unit 204 displays various clause titles associated with the document template tree 304. The clause selection module 206 processes an input of the user 102 to select the safety and health policy 308. The safety and health policy 308 that includes a first metadata. The user 102 performs a right click on a title of the clause safety and health policy 308, and selects the sanitary facilities policy 310. The sanitary facilities policy 310 includes a second metadata. In one embodiment, the user 102 may also select a second clause (e.g., a confidential information policy) from other document template trees (e.g., non-disclosure agreement) that is stored in the master clause database 304, when the user 102 desires to merge the confidential information policy with the safety and health policy 308. The clause combination module 208 allows the user 102 to select an indication of merging of the clause safety and health policy 308 with the sanitary facilities policy 310. Then, the clause merge module 210 processes a user input and merges the safety and health policy 308 and the sanitary facilities policy 310.

FIG. 4D illustrates an exemplary view of merging the safety and health policy 308 with the sanitary facilities policy 310 of the document template tree 304 of FIG. 3 by dragging content of the safety and health policy 308 according to an embodiment herein. The clause merge module 210 processes an input of the user 102 for dragging (i) one or more child clauses of the safety and health policy 308 such as the safe working conditions policy 402, the right to refuse work 404, and the let off policy 406, and dropping it into the sanitary facilities 310, and/or dragging (ii) content of the first aid attendant 408 of the safety and health policy 308, and dropping it into content of the first aid training 416 of the sanitary facilities policy 310 to obtain a safety, health and sanitary facilities policy 436 with a new child clause first aid policy 438. In one embodiment, a title of a merged clause is unchanged such as remains a title of a first clause or a second clause. In another embodiment, a title of a merged clause is changed. In the example of FIG. 4D, title of the merged clause (the safety, health and sanitary facilities policy 436) is changed.

FIG. 4E illustrates an exemplary view of merging the safety and health policy 308 with the sanitary facilities policy 310 of the document template tree 304 of FIG. 3 by dragging content of the sanitary facilities policy 310 according to an embodiment herein. The clause merge module 210 processes an input of the user 102 for dragging (i) one or more child clauses of the sanitary facilities policy 310 such as the washrooms policy 410, the lockers policy 412, and the heating and ventilation policy 414, and dropping it into the safety and health policy 308, and/or dragging (ii) content of the sanitary facilities policy 310 such as the first aid training policy 416, and dropping it into the content of the safety and health policy 308 such as into the first aid attendant 408 to obtain the safety, health and sanitary facilities policy 436 of FIG. 4D.

In one embodiment, the user 102 selects an option of dragging and dropping (not shown in the figures), then the document editing tool performs dragging and dropping of the safety and health policy 308 or the sanitary facilities policy 310 to obtain the safety, health and sanitary facilities policy 436 of FIG. 4D. In another embodiment, each clause of the document template tree 304 is assigned with a clause number. The user 102 selects the safety and health policy 308 and selects the sanitary facilities policy 310 to merge by inputting a clause number of the safety and health policy 308 and the sanitary facilities policy 310.

The clause editing module 212 allows the user 102 to edit the content of (i) the safety and health policy 308, (ii) the sanitary facilities policy 310, and/or (iii) the safety, health and sanitary facilities policy 436. The safety, health and sanitary facilities policy 436 is updated to an edited safety, health and sanitary facilities policy (not shown in the figures).

FIG. 4F illustrates an exemplary view of a content of an edited safety, health and sanitary facilities policy 440 according to an embodiment herein. For instance, editing the safety, health and sanitary facilities policy 436 includes modifying content of the first aid policy 438 with reference to (i) a gender. For example, a gender of the content of the first aid policy 438 is a masculine gender. However, the gender of the edited safety, health and sanitary facilities policy 440 that includes an updated first aid policy 442 is edited to a neutral gender. Editing content of the safety, health and sanitary facilities policy 436 further includes modifying the content of the first aid policy 438 with reference to (ii) a singular or a plural. For example, the content of the first aid policy 438 is provided in a context of a singular. However, the content of the updated first aid policy 442 is edited in a context of a plural.

Editing content of the safety, health and sanitary facilities policy 436 further includes modifying the content of the first aid policy 438 with reference to (iii) a redundancy check, for example, the word “any” is removed from the first aid policy 438. Since, the content of the updated first aid policy 442 is provided in a context of plural (co-workers), the word “any co-workers” makes a redundancy. Therefore, the word “any” is removed from the content of the first aid policy 438 to obtain the updated first aid policy 442. Editing content of the safety, health and sanitary facilities policy 436 further includes modifying the content of the first aid policy 438 with reference to (iv) including a linking content between the content of the first aid attendant policy 408 and the content of the first aid training policy 416. For example, the term “Additionally, to have adequate number of well trained First Aid Attendants” is added to the first aid policy 438 as a linking content to substantiate the edited safety, health and sanitary facilities policy 440.

The metadata update module 214 process a user input to generate a third metadata for the edited safety, health and sanitary facilities policy based on the first metadata of the first clause and the second metadata of the second clause. The document update module 216 process a user input and updates the edited safety, health and sanitary facilities policy to the document template tree 304 and to the master clause database 302. In one embodiment, the edited safety, health and sanitary facilities policy may be updated to another document template tree that is stored in the master clause database 302 of FIG. 3.

FIG. 4G illustrates a various methods of combining a first clause with a second clause to obtain a merged clause that is edited to obtain an edited merged clause according to an embodiment herein. For example, the first clause is the safety and health policy 308 of the document template tree 304, and the second clause is the sanitary facilities policy 310. The clause editing tool 212 process a user input and combines the safety and health policy 308 with sanitary facilities policy 310 to obtain the safety, health and sanitary facilities policy 436 that is updated to obtain the edited safety, health and sanitary facilities policy 440 is performed at least one of the steps of: (i) modifying a content of the safety and health policy 308 and combining with a content of the sanitary facilities 310, (ii) modifying the content of the sanitary facilities 310 and combining with the content of the safety and health policy 308, (iii) modifying the content of the safety and health policy 308 and combining with a modified content of the sanitary facilities 310, and/or (iv) combining the content of the safety and health policy 308 and the content of the sanitary facilities 310.

Throughout description of various embodiments herein, only two different clauses are illustrated to combine into a single clause. However, in one embodiment more than two clauses are combined into a single merged clause. For example, when the drafter 108 intents to combine the safe working conditions policy 402 and the first aid attendant policy 408 of FIG. 4D with the first aid training policy 416 of FIG. 4D, the clause merge module 210 processes a input of the drafter 108 for dragging content of the safe working conditions policy 402 and the first aid attendant policy 408, and dropping it into content of the first aid training policy 416 (not shown in the figures).

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor. The embodiments herein may comprise hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

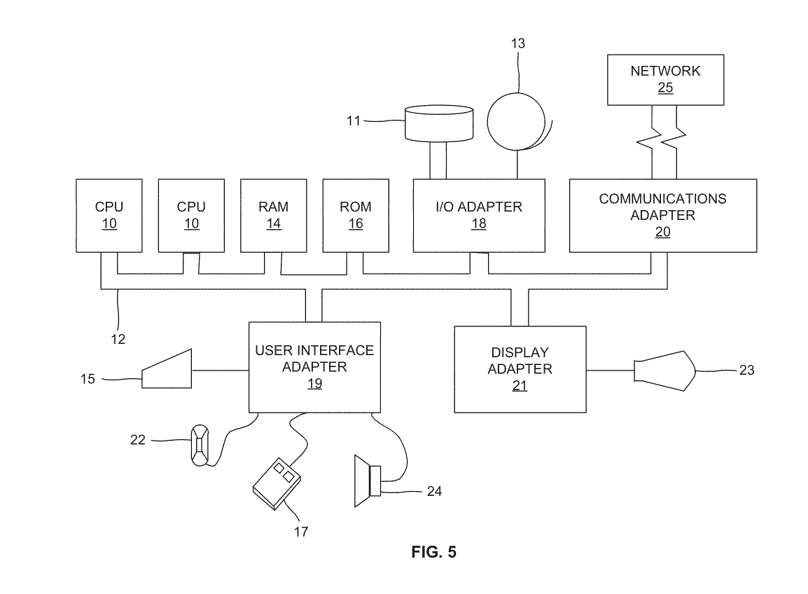

A representative hardware environment for practicing the embodiments herein is depicted in FIG. 5. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A document editing tool that allows merging a first clause and a second clause to obtain a merged clause, said document editing tool comprising:
a memory unit that stores a database and a set of instructions, wherein said database comprises a master clause database and a plurality of document template trees that correspond to a plurality of document types, wherein a document template tree is selected from said plurality of document template trees;
a processor that executes said set of instructions comprising:
displaying, by a display unit, said document template tree, wherein said document template tree comprises at least one parent clause and at least one child clause that are arranged hierarchically;
processing a selection of said first clause from said document template tree, wherein said first clause comprises a first metadata;
processing a selection of said second clause to merge with said first clause, wherein said second clause comprises a second metadata;
processing an input, by an input unit, comprising an indication to combine said first clause with said second clause; and
generating, by said processor, said merged clause in said document template tree that comprises a content of said first clause and a content of said second clause.

2. The document editing tool of claim 1, wherein said set of instructions further comprise generating an electronic document based on said merged clause.

3. The document editing tool of claim 1, wherein said indication to combine comprises dragging and dropping at least one of (i) said first clause into said second clause, or (ii) said content of said first clause into said content of said second clause.

4. The document editing tool of claim 1, wherein said indication to combine further comprises dragging and dropping at least one of (i) said second clause into said first clause, or (ii) said content of said second clause into said content of said first clause.

5. The document editing tool of claim 1, wherein said second clause is selected from said document template tree.

6. The document editing tool of claim 1, wherein said document template tree is a first document template tree and said second clause is selected from a second document template tree, wherein said second document template tree is stored in a master clause database.

7. The document editing tool of claim 1, wherein said set of instructions further comprise:
editing content of at least one of (i) said first clause, (ii) said second clause, and (iii) said merged clause to obtain an edited merged clause; and
storing said edited merged clause in said document template tree and said master clause database by generating a third metadata for said edited merged clause based on said first metadata and said second metadata.

8. The document editing tool of claim 7, wherein said editing comprises editing with reference to at least one of: (i) a gender, (ii) a singular or a plural, (iii) a removal of redundancy, (iv) an inclusion of a linking content between said content of said first clause and said content of said second clause.

9. A method of merging a first clause and a second clause to obtain an edited merged clause, said method comprising:
displaying, by a display unit a document template tree that is stored in a master clause database of a database, wherein said document template tree comprises at least one parent clause and at least one child clause that are arranged hierarchically, wherein said database is stored in a memory unit of a document editing tool;
processing by a processor a selection of said first clause from said document template tree that is stored in said master clause database, wherein said first clause comprises a first metadata;
processing by said processor a selection of said second clause to merge with said first clause, wherein said second clause comprises a second metadata;
processing an input, from an input unit, comprising an indication to combine said first clause with said second clause;
generating a merged clause in said document template tree that comprises a content of said first clause and a content of said second clause; and
updating at least one of (i) said first clause, (ii) said second clause, and (iii) said merged clause to obtain said edited merged clause.

10. The method of claim 9, further comprising generating an electronic document based on said edited merged clause.

11. The method of claim 9, further comprising updating said edited merged clause in said document template tree and a master clause database by generating a third metadata for said edited merged clause based on said first metadata and said second metadata.

12. A document editing tool that allows merging a first clause and a second clause to obtain a merged clause, said document editing tool comprising:
a memory unit that stores (i) a set of modules, and (ii) a database that comprises a master clause database and a plurality of document template trees that correspond to a plurality of document types;
a display unit that is capable of displaying said plurality of document template trees stored in said master clause database; and
a processor that executes said set of modules, wherein said set of modules comprises:
i) a clause selection module that is capable of processing a selection of said first clause and said second clause;
ii) a clause combination module that is capable of processing an input comprising an indication to combine said first clause with said second clause; and
iii) a clause merge module that is capable of generating a merged clause that comprises a content of said first clause and a content of said second clause.

13. The document editing tool of claim 12, wherein said set of modules further comprise a clause editing module that is capable of editing at least one of (i) said content of said first clause, (ii) said content of said second clause, and (iii) a content of said merged clause to obtain an edited merged clause.

14. The document editing tool of claim 12, wherein said set of modules further comprise a metadata update module that is capable of updating a third metadata for said edited merged clause based on said first metadata and said second metadata.

15. The document editing tool of claim 12, wherein said set of modules further comprise a document update module that is capable of updating said edited merged clause in said document template tree and said master clause database.
